(19) United States
(12) Patent Application Publication
(10) Pub. No.: US 2007/0226633 A1
(43) Pub. Date: Sep. 27, 2007

(54) Copying and pasting portlets in a portal environment

(75) Inventors: Ruthie D. Lyle, Durham, NC (US); Arthur R. Francis, Raleigh, NC (US); Veronique Moses, Raleigh, NC (US); Martin J. Presler-Marshall, Chapel Hill, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/368,722

(22) Filed: Mar. 6, 2006

(51) Int. Cl. G06F 17/00

(52) U.S. Cl. 715/742; 715/507

(57) ABSTRACT

The present invention provides the copying and pasting of a portlet in a portal environment. A method in accordance with an embodiment of the present invention includes: providing a first instance of a portlet, the first instance of the portlet including encoded information; copying the encoded information; and creating a second instance of the portlet using the encoded information. The encoded information includes an identification of the portlet and configuration parameters applied to the portlet.

### BACKGROUND OF THE INVENTION

1. Field of the Invention

The present invention generally relates to portlets, and more specifically relates to the copying and pasting of portlets in a portal environment.

2. Related Art

Copy and paste is a common, useful user interface method used in many desktop systems. Desktop systems (such as Windows, OS/2, OS X, and KDE) have developed systems to support the copying of information from a source application and the subsequent pasting of the information into a target application. The source application understands the meaning of the copied information, so it is able to make the copied information available to the target application as a rich object. For example, text can be copied from a word processor to an e-mail program, and formatting, such as fonts and text size, can be included in the copy operation, because the source application has complete knowledge of the information being copied.

The copying and pasting of information is much more difficult to handle in a Web-based environment. For instance, when a user is interacting with a Web application, the Web application server has knowledge of the objects the user is interacting with, but this information does not flow from the Web application server to the Web browser of the user. Instead, the Web application server sends to the Web browser only markup which can be used to display (e.g., in a portlet) the current state of the Web application. Thus, a copy and paste operation from a Web browser can only copy the presented formatted text and images—it cannot copy rich, meaningful objects because such objects exist only at the Web application server, which is not involved in the copy and paste operation.

An example of this problem is found in the world of a Web portal. A Web portal can display multiple Web applications (“portlets”) on a single portal page. From the point of view of the Web application server, each portlet is a meaningful object (e.g., the name/ID of the portlet, the portlet's configuration information, and so on). However, this rich information is never transmitted to the Web browser; the Web browser only sees a markup stream which can be used to display the current state of each portlet. To this extent, attempting to copy a portlet on a portal page using a copy and paste operation is not possible, because all of the information which represents the portlet exists only at the Web application server, not at the Web browser. Thus, instead of being able to simply copy a portlet on a portal page and then paste the portlet on the same or different portal page, a user must search for the portlet on one or more Web application servers and, if found, add the portlet using a page customization application. This process can be very time consuming.

### SUMMARY OF THE INVENTION

The present invention allows a user to copy and paste portlets in a portal environment. In particular, the present invention recognizes that a barrier to supporting richer copy and paste operations involving Web applications (e.g., portlets) is that knowledge of the objects involved is not transmitted from the Web application server to the Web browser. The present invention resolves this problem by expanding the information transmitted from the Web application server to the Web browser to contain not just display information, but also encoded information about the underlying objects in the Web application.

A first aspect of the present invention is directed to a method for copying and pasting a portlet, comprising: providing a first instance of a portlet, the first instance of the portlet including encoded information; copying the encoded information; and creating a second instance of the portlet using the encoded information.

A second aspect of the present invention is directed to a system for copying and pasting a portlet, comprising: a system for providing a first instance of a portlet, the first instance of the portlet including encoded information; a system for copying the encoded information; and a system for creating a second instance of the portlet using the encoded information.

A third aspect of the present invention is directed to a program product stored on a computer readable medium for copying and pasting a portlet, the computer readable medium comprising program code for performing the steps of: providing a first instance of a portlet, the first instance of the portlet including encoded information; copying the encoded information; and creating a second instance of the portlet using the encoded information.

A fourth aspect of the present invention is directed to a method for deploying an application for copying and pasting a portlet, comprising: providing a computer infrastructure being operable to: provide a first instance of a portlet, the first instance of the portlet including encoded information; copy the encoded information; and create a second instance of the portlet using the encoded information

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts the copying and pasting of a portlet in a portal environment in accordance with an embodiment of the present invention.

FIG. 2 depicts an illustrative flow diagram of a process for copying and pasting a portlet in a portal environment in accordance with an embodiment of the present invention.

FIG. 3 depicts an illustrative implementation of the present invention in a Web page/portal customization application.

FIG. 4 depicts an illustrative computer system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As detailed above, the present invention allows a user to copy and paste portlets in a portal environment. In particular, the present invention recognizes that a barrier to supporting richer copy and paste operations involving Web applications (e.g., portlets) is that knowledge of the objects involved is not transmitted from the Web application server to the Web browser. The present invention resolves this problem by expanding the information transmitted from the Web application server to the Web browser to contain not just display information, but also encoded information about the underlying objects in the Web application. Although the present invention will be described below with regard to the copying and pasting of a specific type of Web application, namely portlets, it can also be used for the copying and pasting of many other types of Web applications.

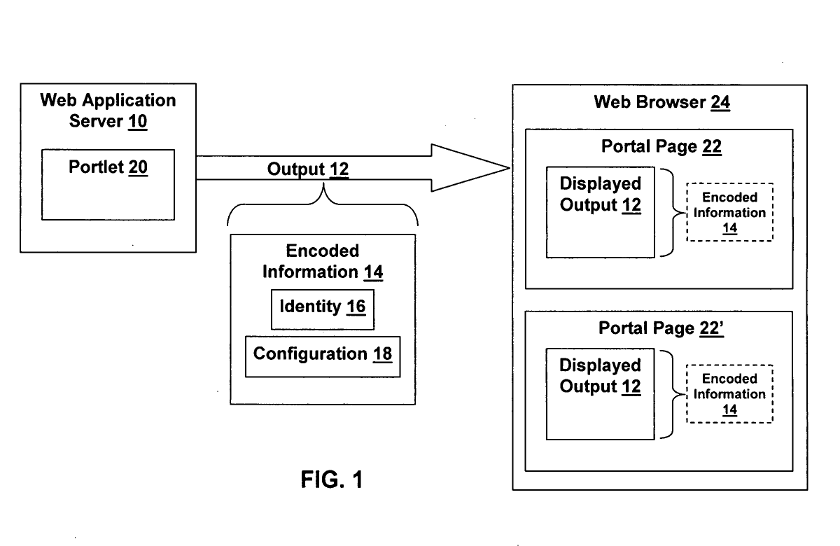

In accordance with the present invention, as depicted in FIG. 1, a Web application server 10 provides, in its output 12, encoded information 14 that includes the identity 16 and configuration parameters 18 of the portlet 20 that generated the output 12. The encoded information 14 can be transmitted in the output 12 of the portlet 20 as an encoded URL (Uniform Resource Locator) or HTML (HyperText Markup Language) form, or in any other suitable manner. The display information (i.e., markup) in the output 12 of the portlet 20 is displayed in a portal page 22 by a Web browser 24. As shown in phantom, the encoded information 14 in the output 12 of the portlet 20 is not displayed in the portal page 22 by the Web browser 24, but is available for copying and pasting.

By providing the encoded information 14, a user can now copy the portlet 20 from the portal page 22 and paste the portlet 20 into another portal page 22′ (or into the same portal page 22). This is done by copying the encoded information 14 and then pasting the encoded information 14 into the target portal page 22′. Since the encoded information 14 contains the identity 16 (e.g., name or ID) and configuration parameters 18 of the portlet 20, a new instance of the portlet 20 can be placed on the portal page 22′. In particular, using the identity 16 of the portlet 20, the portlet 20 is located (e.g., in a portlet catalog) on the Web application server 10. The Web application server 10 then creates a new instance of the portlet 20, adds the new instance of the portlet 20 to the portal page 22′, and applies the configuration parameters 18 to the portlet 20. The portlet 20 is thus copied from the portal page 22 to the portal page 22′. The encoded information 14 can be included with the portal page 22′ to allow the portal page 22′ to be copied and pasted in a similar manner. The target portal page 22′ may be associated with another, independent portal instance. As such, in accordance with the present invention, the portlet 20 can be copied across independent portal instances.

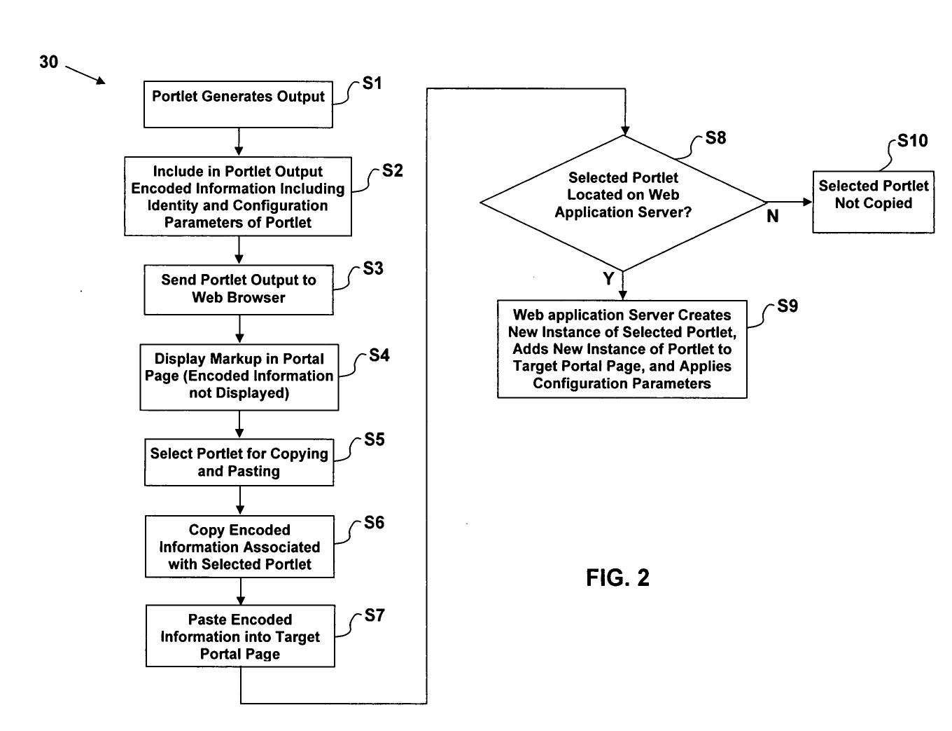

An illustrative flow diagram 30 of a process for copying and pasting a portlet in a portal environment in accordance with an embodiment of the present invention is illustrated in FIG. 2. The flow diagram 30 is described below with regard to the system components depicted in FIG. 1.

In step S1, the portlet 20 in the Web application server 10 generates output 12. In step S2, the Web application server 10 provides, in the output 12, encoded information 14 that includes the identity 16 and configuration parameters 18 of the portlet 20. In step S3, the output 12 is sent to a Web browser 24. In step S4, the display information (i.e., markup) in the output 12 of the portlet 20 is displayed in a portal page 22 by the Web browser 24. The encoded information 14 in the output 12 of the portlet 20, however, is not displayed in the portal page 22 by the Web browser 24, but is available for copying and pasting from the portal page 22.

In step S5, a user selects the portlet 20 on the portal page 22 for copying and pasting. In step S6, the encoded information 14 associated with the selected portlet 20 is copied. In step S7, the user pastes the encoded information 14 into a target portal page 22′.

In step S8, the portlet 20 is located on the Web application server 10 using the identity 16 of the portlet 20 provided in the encoded information 14. If, for some reason (e.g., due to deletion, modification, etc.), it is determined that the portlet 20 is not available on the Web application server 10, then the portlet 20 is not copied (step S10). If, however, the portlet 20 is available on the Web application server 10, then in step S9, the Web application server 10 creates a new instance of the portlet 20, adds the new instance of the portlet 20 to the target portal page 22′, and applies the configuration parameters 18 included in the encoded information to the portlet 20.

The encoding of the identity and configuration parameters of a portlet can be done in a private format (e.g., set by a vendor) which can only be interpreted by a Web application server from the same vendor and/or by other authorized vendor(s)/user(s). An extension of this idea would be to standardize the format and meaning of the encoded information, allowing the copy and paste operation to occur across different Web sites using application servers from different vendors.

In accordance with another embodiment of the present invention, if the format and meaning of the encoded information is described in a standardized way, then Web-based applications can be fully involved in copy-and-paste operations with desktop applications. This can be accomplished by defining an encoding which can be transmitted as part of a markup stream which will capture the data types possible for desktop copy and paste operations. For example, a Web-based spreadsheet application could encode its data as a spreadsheet object, not simply as a grid of numeric values, allowing copying and pasting between a Web-based spreadsheet and a desktop-based spreadsheet application.

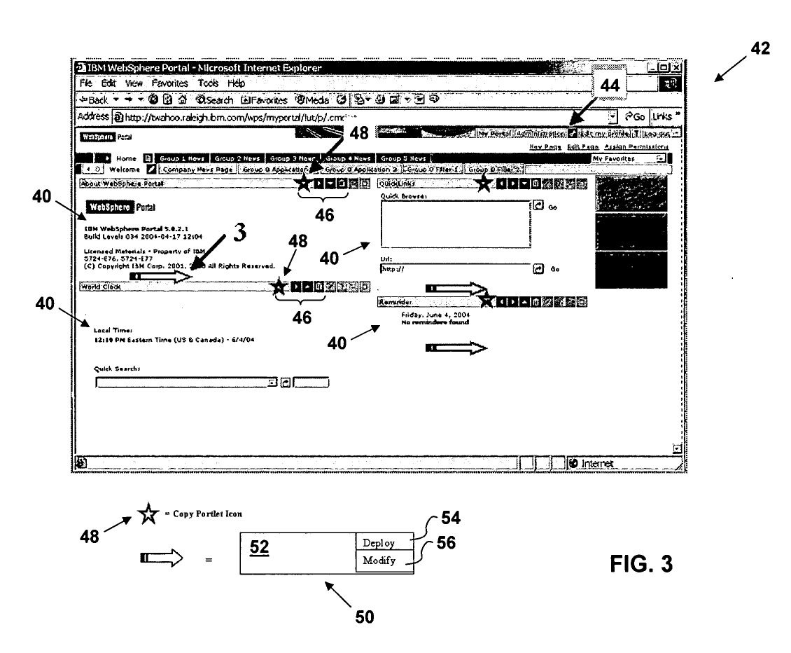

An illustrative implementation of the present invention in a Web page/portal customization application (e.g., IBM WebSphere Portal) is illustrated in FIG. 3. This type of application allows a user to add/delete portlets 40 from a portal page 42, rearrange portlets 40 on the portal page 42, and perform other portal page customization tasks.

After a logging onto the portal page 42, a user can actuate a “Show Tools” button 44 or other suitable mechanism to display one or more sets of links 46 that can be used to customize portlets 40 on the portal page 42. In accordance with the present invention, each set of links 46 can include a “Copy Portlet” link 48, which allows the copying and pasting of a respective portlet 40. In particular, actuation of a Copy Portlet link 48 results in the capture of the encoded information containing the identity and configuration parameters of the respective portlet 40.

Place holder boxes 50 (represented by the block arrows) are provided in open real estate areas of the portal page 42 where a new portlet 40 can be added/inserted. Each place holder box 50 includes a field 52 into which the copied encoded information can be pasted. Each place holder box 50 further includes a deploy button 54. When the deploy button 54 is actuated by a user, a new portlet 40 is deployed on the portal page 42 using encoded information previously pasted into the field 52 of the place holder box 50. By default, when a portlet 40 is copied, the copied portlet 40 uses the same resources (e.g., configuration parameters) as the original (source) portlet 40. However, a user may access and modify the resources by actuating a modify button 56 included in the place holder box 50 prior to deploying the portlet 40. The copy and paste operation can be performed across independent portal instances using, for example, a clipboard as an intermediate storage location.

The present invention provides numerous advantages including, for example:
(A) Allows for “Copy and Paste” of portlets, even across independent portal instances;
(B) Reduces the number of steps and the complexity thereof required for copying portlets;
(C) Promotes portlet code reusability; and
(D) Well suited for virtual portal management.

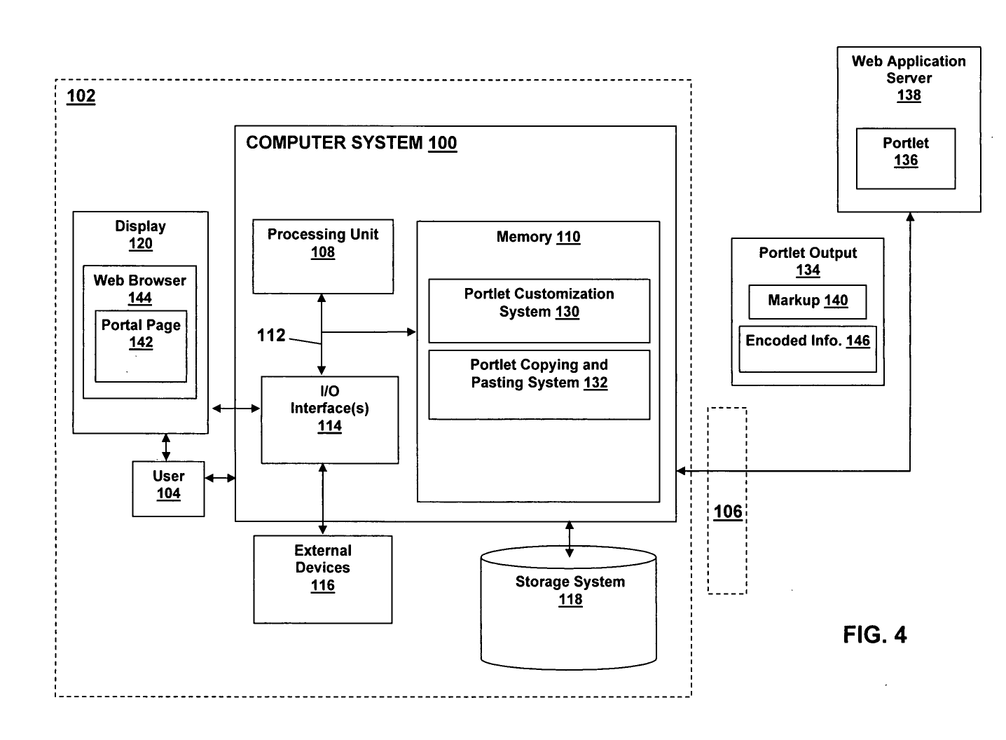

A computer system 100 for copying and pasting a portlet in accordance with an embodiment of the present invention is depicted in FIG. 4. The computer system 100 is provided in a computer infrastructure 102. The computer system 100 is intended to represent any type of computer system capable of carrying out the teachings of the present invention. For example, the computer system 100 can be a laptop computer, a desktop computer, a workstation, a handheld device, a server, a cluster of computers, etc. In addition, as will be further described below, the computer system 100 can be deployed and/or operated by a service provider that provides a service for copying and pasting a portlet in accordance with the present invention. It should be appreciated that a user 104 can access the computer system 100 directly, or can operate a computer system that communicates with the computer system 100 over a network 106 (e.g., the Internet, a wide area network (WAN), a local area network (LAN), a virtual private network (VPN), etc). In the case of the latter, communications between the computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

The computer system 100 is shown including a processing unit 108, a memory 110, a bus 112, and input/output (I/O) interfaces 114. Further, the computer system 100 is shown in communication with external devices/resources 116 and one or more storage systems 118. In general, the processing unit 108 executes computer program code, such as portal customization system 130 (e.g., IBM WebSphere Portal) and portlet copying and pasting system 132, stored in memory 110 and/or storage system(s) 118. While executing computer program code, the processing unit 108 can read and/or write data, to/from the memory 110, the storage system(s) 118, and/or the I/O interfaces 114. The bus 112 provides a communication link between each of the components in the computer system 100. The external devices/resources 116 can comprise any devices (e.g., keyboard, pointing device, display (e.g., display 120, printer, etc.) that enable a user to interact with the computer system 100 and/or any devices (e.g., network card, modem, etc.) that enable the computer system 100 to communicate with one or more other computing devices.

The computer infrastructure 102 is only illustrative of various types of computer infrastructures that can be used to implement the present invention. For example, in one embodiment, the computer infrastructure 102 can comprise two or more computing devices (e.g., a server cluster) that communicate over a network (e.g., network 106) to perform the various process steps of the invention. Moreover, the computer system 100 is only representative of the many types of computer systems that can be used in the practice of the present invention, each of which can include numerous combinations of hardware/software. For example, the processing unit 108 can comprise a single processing unit, or can be distributed across one or more processing units in one or more locations, e.g., on a client and server. Similarly, the memory 110 and/or storage system(s) 118 can comprise any combination of various types of data storage and/or transmission media that reside at one or more physical locations. Further, the I/O interfaces 114 can comprise any system for exchanging information with one or more external devices/resources 116. Still further, it is understood that one or more additional components (e.g., system software, communication systems, cache memory, etc.) not shown in FIG. 4 can be included in the computer system 100. However, if computer system 100 comprises a handheld device or the like, it is understood that one or more external devices/resources 116 (e.g., a display) and/or one or more storage system(s) 118 can be contained within the computer system 100, and not externally as shown.

The storage system(s) 118 can be any type of system (e.g., a database) capable of providing storage for information under the present invention. To this extent, the storage system(s) 118 can include one or more storage devices, such as a magnetic disk drive or an optical disk drive. In another embodiment, the storage system(s) 118 can include data distributed across, for example, a local area network (LAN), wide area network (WAN) or a storage area network (SAN) (not shown). Moreover, although not shown, computer systems operated by user 104 can contain computerized components similar to those described above with regard to computer system 100.

Shown in the memory 110 (e.g., as a computer program product) is a portal customization system 130, and a portlet copying and pasting system 132 in accordance with the present invention, as described above. The portlet copying and pasting system 132 receives output 134 generated by a portlet 136 running on a Web application server 138. The output 134 contains markup 140 for display (e.g., on display 120) in a portal page 142 by a web browser 144. The output 134 further includes encoded information 146, which includes the identity and configuration parameters of the portlet 136.

Using, for example, the portal customization system 130, the user 104 can copy and paste the portlet 136 into the same or a different portal page 142. In general, a user selects the portlet 136 displayed on the portal page 142 for copying and pasting. The encoded information 146 associated with the selected portlet 136 is copied and sent to the Web application server 138. Using the identity of the portlet 136 included in the encoded information 146, the Web application server 138 creates a new instance of the portlet 136, adds the new instance of the portlet 136 to a (user) selected area of the portal page 142, and applies the configuration parameters included in the encoded information to the portlet 136.

The present invention can be offered as a business method on a subscription or fee basis. For example, one or more components of the present invention can be created, maintained, supported, and/or deployed by a service provider that offers the functions described herein for customers. That is, a service provider can be used to provide a service for copying and pasting a portlet, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk-read only disk (CD-ROM), a compact disk—read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method for copying and pasting a portlet, comprising:
providing a first instance of a portlet, the first instance of the portlet including encoded information;
copying the encoded information; and
creating a second instance of the portlet using the encoded information.

2. The method of claim 1, wherein the encoded information includes an identification of the portlet.

3. The method of claim 1, wherein the encoded information includes configuration parameters applied to the portlet.

4. The method of claim 1, wherein the first instance of the portlet is provided on a portal page, and wherein the second instance of the portlet is created on the portal page.

5. The method of claim 1, wherein the first instance of the portlet is provided on a portal page, and wherein the second instance of the portlet is created on another portal page.

6. The method of claim 1, wherein the first instance of the portlet is associated with a first portal instance, and wherein the second instance of the portlet is associated with a second portal instance.

7. The method of claim 6, wherein the first and second portal instances are independent of each other.

8. A system for copying and pasting a portlet, comprising:
a system for providing a first instance of a portlet, the first instance of the portlet including encoded information;
a system for copying the encoded information; and
a system for creating a second instance of the portlet using the encoded information.

9. The system of claim 8, wherein the encoded information includes an identification of the portlet.

10. The system of claim 8, wherein the encoded information includes configuration parameters applied to the portlet.

11. The system of claim 8, wherein the first instance of the portlet is provided on a portal page, and wherein the second instance of the portlet is created on the portal page.

12. The system of claim 8, wherein the first instance of the portlet is provided on a portal page, and wherein the second instance of the portlet is created on another portal page.

13. The system of claim 9, wherein the first instance of the portlet is associated with a first portal instance, and wherein the second instance of the portlet is associated with a second portal instance.

14. The system of claim 13, wherein the first and second portal instances are independent of each other.

15. A program product stored on a computer readable medium for copying and pasting a portlet, the computer readable medium comprising program code for performing the steps of:
providing a first instance of a portlet, the first instance of the portlet including encoded information;
copying the encoded information; and
creating a second instance of the portlet using the encoded information.

16. The program product of claim 15, wherein the encoded information includes an identification of the portlet.

17. The program product of claim 15, wherein the encoded information includes configuration parameters applied to the portlet.

18. The program product of claim 15, wherein the first instance of the portlet is provided on a portal page, and wherein the second instance of the portlet is created on the portal page.

19. The program product of claim 15, wherein the first instance of the portlet is provided on a portal page, and wherein the second instance of the portlet is created on another portal page.

20. The program product of claim 15, wherein the first instance of the portlet is associated with a first portal instance, and wherein the second instance of the portlet is associated with a second portal instance.

21. The program product of claim 20, wherein the first and second portal instances are independent of each other.
